(19) United States
(12) Patent Application Publication
(10) Pub. No.: US 2025/0148624 A1
(43) Pub. Date: May 8, 2025

(54) MULTI-CAMERA ENTITY TRACKING TRANSFORMER MODEL

(71) Applicant: NEC Laboratories America, Inc., Princeton, NJ (US)

(72) Inventors: Deep Patel, Franklin Park, NJ (US); Iain Melvin, Princeton, NJ (US); Alexandru Niculescu-Mizil, Plainsboro, NJ (US)

(21) Appl. No.: 18/934,512

(22) Filed: Nov. 1, 2024

Related U.S. Application Data
(60) Provisional application No. 63/595,948, filed on Nov. 3, 2023.
(60) Provisional application No. 63/548,537, filed on Nov. 14, 2023.

(51) Int. Cl. G06T 7/292; G06T 7/00; G06T 7/70

(52) U.S. Cl. CPC G06T 7/292; G06T 7/0002; G06T 7/70; G06T 2207/10016; G06T 2207/20081; G06T 2207/20084

(57) ABSTRACT

Systems and methods for a multi-entity tracking transformer model (MCTR). To train the MCTR, processing track embeddings and detection embeddings of video feeds obtained from multiple cameras to generate updated track embeddings with a tracking module. The updated track embeddings can be associated with the detection embeddings to generate track-detection associations (TDA) for each camera view and camera frame with an association module. A cost module can calculate a differentiable loss from the TDA by combining a detection loss, a track loss and an auxiliary track loss. A model trainer can train the MCTR using the differentiable loss and contiguous video segments sampled from a training dataset to track multiple objects with multiple cameras.

### RELATED APPLICATION INFORMATION

This application claims priority to U.S. Provisional App. No. 63/595,948, filed on Nov. 3, 2023, and to U.S. Provisional App. No. 63/548,537, filed on Nov. 14, 2023, incorporated herein by reference in their entirety.

### BACKGROUND

### Technical Field

The present invention relates to object detection using artificial intelligence and more particularly to a multi-camera entity tracking transformer model.

### Description of the Related Art

Artificial intelligence (AI) models have improved dramatically over the years especially in entity detection, scene reconstruction, anomaly detection, trajectory generation, and scene understanding. However, the accuracy of the AI models are directly proportional to the quality of data that they are trained with. Noise such as occlusions and blind spots can hinder the accuracy of detection models. Thus, reducing noise in the data for AI models is an important issue that needs to be addressed.

### SUMMARY

According to an aspect of the present invention, a method is provided for tracking multiple objects with multiple cameras using a transformer-based model (MCTR), including, processing track embeddings and detection embeddings of video feeds obtained from multiple cameras to generate updated track embeddings, associating the updated track embeddings with the detection embeddings to generate track-detection associations (TDA) for each camera view and camera frame, calculating a differentiable loss from the TDA by combining a detection loss, a track loss and an auxiliary track loss, and training the MCTR using the differentiable loss and contiguous video segments sampled from a training dataset to track multiple objects with multiple cameras to obtain a trained MCTR.

According to another aspect of the present invention, a system is provided for tracking multiple objects with multiple cameras using a transformer-based model (MCTR), including a memory device, one or more processor devices operatively coupled with the memory device to process track embeddings and detection embeddings of video feeds obtained from multiple cameras to generate updated track embeddings, associate the updated track embeddings with the detection embeddings to generate track-detection associations (TDA) for each camera view and camera frame, calculate a differentiable loss from the TDA by combining a detection loss, a track loss and an auxiliary track loss, and train the MCTR using the differentiable loss and contiguous video segments sampled from a training dataset to track multiple objects with multiple cameras to obtain a trained MCTR.

According to yet another aspect of the present invention, a non-transitory computer program product is provided including a computer-readable storage medium having program code for tracking multiple objects with multiple cameras using a transformer-based model (MCTR), wherein the program code when executed on a computer causes the computer to process track embeddings and detection embeddings of video feeds obtained from multiple cameras to generate updated track embeddings, associate the updated track embeddings with the detection embeddings to generate track-detection associations (TDA) for each camera view and camera frame, calculate a differentiable loss from the TDA by combining a detection loss, a track loss and an auxiliary track loss, and train the MCTR using the differentiable loss and contiguous video segments sampled from a training dataset to track multiple objects with multiple cameras to obtain a trained MCTR.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a computer-implemented method for tracking multiple objects with multiple cameras using a transformer-based model (MCTR), in accordance with an embodiment of the present invention;

FIG. 2 is a block diagram illustrating a system for a multi-camera entity tracking transformer model, in accordance with an embodiment of the present invention;

FIG. 3 is a block diagram illustrating a system for a multi-camera entity tracking transformer model, in accordance with an embodiment of the present invention;

FIG. 4 is a block diagram illustrating a system for the tracking module, in accordance with an embodiment of the present invention;

FIG. 5 is a block diagram illustrating a system for the association module, in accordance with an embodiment of the present invention;

FIG. 6 is a block diagram illustrating a system implementing a practical application for a multi-camera entity tracking transformer model, in accordance with an embodiment of the present invention; and

FIG. 7 is a block diagram illustrating deep learning neural networks for a multi-camera entity tracking transformer model, in accordance with an embodiment of the present invention.

### DETAILED DESCRIPTION OF PREFERRED EMBODIMENTS

In accordance with embodiments of the present invention, systems and methods are provided for tracking multiple objects with multiple cameras using a transformer-based model (MCTR).

In an embodiment, transformer-based model for tracking multiple objects with multiple cameras (MCTR) can be trained. To train the MCTR, processing track embeddings and detection embeddings of video feeds obtained from multiple cameras to generate updated track embeddings with a tracking module. The updated track embeddings can be associated with the detection embeddings to generate track-detection associations (TDA) for each camera view and camera frame with an association module. A cost module can calculate a differentiable loss from the TDA by combining a detection loss, a track loss and an auxiliary track loss. A model trainer can train the MCTR using the differentiable loss and contiguous video segments sampled from a training dataset to track multiple objects with multiple cameras.

The trained MCTR can be employed to detect anomalies from monitored entities within a specified location to assist the decision-making of a decision-making entity. In another embodiment, the trained MCTR can be employed to perform fine-grained object detection in a specified location crowded with other entities.

Multiple entity tracking has been done using a single-camera. However, single-camera methods are limited by the coverage of its sensor which produces blind spots which further limit their accuracy. Additionally, heuristic-based methods for multiple entity tracking with multiple cameras had been studied. However, accuracy for such methods are limited to the quality and effectiveness of the rules employed.

The present invention solves the problem described above by processing videos from camera feeds in real time. Each frame from each camera can be processed by an end-to-end detector system such as a detection transformer (DETR) that produces detections, bounding boxes and a detection embedding for each detection. A tracking module can maintain a set of track embeddings and updates them by interacting with the information from the detection embeddings for all detections and all cameras. An association module then matches the track embeddings with detection embeddings in each camera view. A consistent track is obtained by taking all detection associated with the same track embedding in all camera views and all frames. To train the parameters of the system, the present invention describes a novel cost module that calculates a differentiable loss based on how well the association predicted by the system matched the true association in the training data.

The present embodiments improve the accuracy and effectiveness of object detection models by increasing coverage, reducing blind spots and occlusions, and increasing tracking robustness over other methods.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

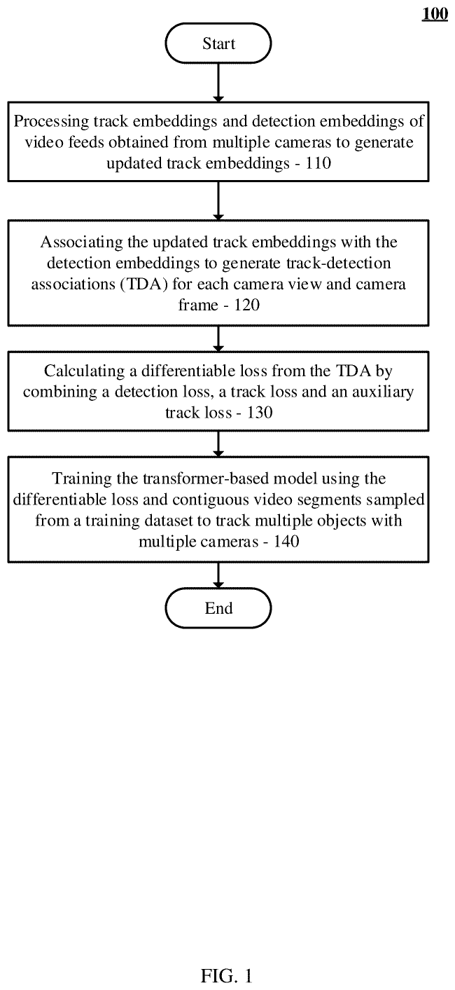

Referring now in detail to the figures in which like numerals represent the same or similar elements and initially to FIG. 1, a high-level overview of a computer-implemented method for tracking multiple objects with multiple cameras using a transformer-based model (MCTR) is illustratively depicted in accordance with one embodiment of the present invention.

In an embodiment, transformer-based model for tracking multiple objects with multiple cameras (MCTR) can be trained. To train the MCTR, processing track embeddings and detection embeddings of video feeds obtained from multiple cameras to generate updated track embeddings with a tracking module. The updated track embeddings can be associated with the detection embeddings to generate track-detection associations (TDA) for each camera view and camera frame with an association module. A cost module can calculate a differentiable loss from the TDA by combining a detection loss, a track loss and an auxiliary track loss. A model trainer can train the MCTR using the differentiable loss and contiguous video segments sampled from a training dataset to track multiple objects with multiple cameras.

The trained MCTR can be employed to detect anomalies from monitored entities within a specified location to assist the decision-making of a decision-making entity. In another embodiment, the trained MCTR can be employed to perform fine-grained object detection in a specified location crowded with other entities.

Referring now to block 110 of FIG. 1 showing an embodiment of a method of processing track embeddings and detection embeddings of video feeds obtained from multiple cameras to generate updated track embeddings.

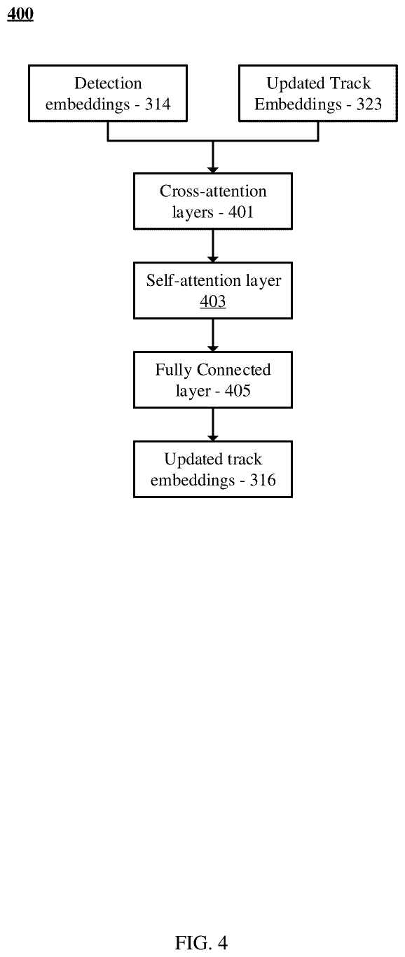

A tracking module is tasked with updating the track embeddings with information from all the camera views in the current frame. The purpose of the track embeddings is to maintain global information about the tracked objects through aggregating observations from a frame into a global track embedding that is included in the updated track embeddings. The architecture of the tracking module is depicted in FIG. 4.

Referring now to FIG. 4 showing an embodiment of a system for the tracking module.

The tracking module 400 can include one or more tracking layers, each can include a cross-attention layer 401, a self-attention layer 403, and a fully connected layer 405 having two feed-forward layers with rectified linear unit (ReLU) nonlinearities, with skip connections and dropout between the cross-attention layers 401, a self-attention layer 403, and a fully connected layer 405. The cross-attention layers 401 can include a set of multi-head cross-attention modules tailored to each camera view, with each module computing cross-attention between the current track embeddings 316, acting as queries, and the detection embeddings 314 from the corresponding camera view. Because the relationship between objects and tracks depends on the camera position, each cross-attention module has its own distinct parameters (e.g., there is no parameter sharing between the cross-attention modules corresponding to the different views). The outputs of all the view specific cross-attention layers 401 are aggregated and averaged and passed through self-attention layers 403 and fully connected layer 405 to obtain updated track embeddings 323.

The updated track embeddings 323 can be cycled back to the tracking module 400 to process the next frame. The updated track embeddings 323 can also be forwarded to the association module 500.

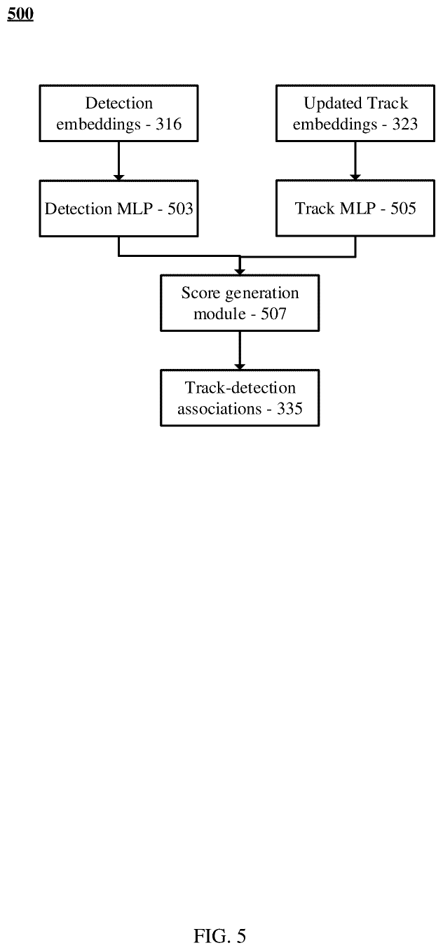

Referring back now to block 120 of FIG. 1 showing an embodiment of a method of associating the updated track embeddings with the detection embeddings to generate track-detection associations (TDA) for each camera view and camera frame. The system architecture for the association module is shown in more detail in FIG. 5.

Referring now to FIG. 5 showing an embodiment of a system for the association module.

The association module 500 can produce a probabilistic assignment of detections to tracks. The assignment can be performed independently for each camera view through a mechanism that is the same as the attention mechanism in scaled dot-product attention, wherein the detections act as queries and tracks act as keys. The detection embeddings 316 and the updated track embeddings 323 undergo a linear transformation by employing a detection multi-layer perceptron (MLP) 503 for the detection embeddings 316 to obtain a detection matrix; and a track MLP 505 for the updated track embeddings 323 to obtain a track matrix. After linear transformation, the track (T) and detection (D) matrix is multiplied to obtain a TD-matrix through the score generation module 507. Similar to scaled attention, the TD-matrix can be scaled by the square root of the embedding dimension before applying a row-wise softmax operation also through the score generation module 507. The result is a D×T matrix Aᵥ where each entry A_{d,t}^{v} represents the probability that detection d is associated with track t in view v. This process can be repeated for every detection detected from each of the cameras.

Referring back now to block 130 of FIG. 1 showing an embodiment of a method of calculating a differentiable loss from the TDA by combining a detection loss, a track loss and an auxiliary track loss.

The differentiable loss can be the final computed loss function that combines the detection loss, a track loss and an auxiliary track loss. The differentiable loss can be computed by the cost module.

To compute the detection loss [symbol] _{det}, given ground truth annotations, Hungarian matching can be used to find the bipartite assignment of detections to ground truth that incurs the lowest loss. This loss is used as a detection loss for each view. Detection losses calculated at different layers of the MCTR transformer decoder can be used as auxiliary losses [symbol] _{det_aux}.

The track loss [symbol] _{track} can enforce consistency of object identity between camera views and camera frames. To compute the track loss [symbol] _{track}, the following formula can be used:

$${ℒ}_{track} = - \frac{1}{{N}_{p}} {\sum }_{{d}_{1} , {d}_{2}} ( {y}_{st} ( {d}_{1} , {d}_{2} ) \cdot log ( {P}_{st} ( {d}_{1} , {d}_{2} ) ) + ( 1 - {y}_{st} ( {d}_{1} , {d}_{2} ) ) \cdot log ( 1 - {P}_{st} ( {d}_{1} , {d}_{2} ) ) ,$$

where

Pₛₜ(d₁,d₂)=ΣₜA_{d}_{₁}ₜ^{v}^{₁}·A_{d}_{₂}ₜ^{v}^{₂}, where A_{d}_{₁}ₜ^{v}^{₁} is the probabilistic assignment matrix for view v₁ for the detection d₁, A_{d}_{₂}ₜ^{v}^{₂} is the probabilistic assignment matrix for view v₂ for the detection d₂, Nₚ is the number of detection pairs (d₁ and d₂).

To obtain a label yₛₜ(d₁,d₂), the detection to ground truth assignment providined by the hungarian matching algorithm. We have three possible cases: yₛₜ(d₁,d₂)=1, if both d₁ and d₂ are associated with a ground truth annotation, and both ground truth annotations have the same track ID. yₛₜ(d₁,d₂)=0, if both d₁ and d₂ are associated with a ground truth annotation, but both ground truth annotations have the different track IDs. yₛₜ(d₁,d₂)=undefined, if either di or d,2 is not associated with any ground truth annotation. The detection pairs d1 and d2 can be obtained from a same camera view but from different frames as [symbol] _{track_frame}.

To compute the auxiliary track loss [symbol] _{aux_track} as the combination of the track IOU loss [symbol] _{track_IOU} and the track GIOU loss [symbol] _{track_GIOU}. The auxiliary track loss can encourage the learning of more informative track embeddings by inducing the track embeddings to encode information about the bounding boxes of a corresponding object in all camera views.

To compute the IOU track loss, the track embeddings are passed, for each view, through three-layer MLP with ReLU nonlinearity to predicts the coordinates \hat{B}(t, v) of the bounding box for the respective track t in view v. The MLPs are view specific, since an object position would be different in different camera views. The track IOU loss can be computed as:

$${ℒ}_{track \_ IOU} = \frac{1}{V \cdot T} {\sum }_{v = 1}^{V} {\sum }_{t = 1}^{T} {\sum }_{d} {A}_{d , t}^{v} \cdot {L}_{IOU} ( \hat{B} ( t , v ) , B ( d ) )$$

where the third sum is taken over all detections d that have been associated by with a ground truth annotation by Hungarian matching for that view, B(d) is the bounding box of that ground truth annotation, and L_{IOU} is the IOU loss, V is the total number of views, T is the total number of tracks. To compute GIOU track loss, the following equation can be employed:

$${ℒ}_{track \_ GIOU} = \frac{1}{V \cdot T} {\sum }_{v = 1}^{V} {\sum }_{t = 1}^{T} {\sum }_{d} {A}_{d , t}^{v} \cdot {L}_{GIOU} ( \hat{B} ( t , v ) , B ( d ) )$$

where, L_{GIOU} is the GIOU loss.

While the bounding boxes predicted from the track embeddings are not as accurate as the ones predicted from the detection embeddings, the auxiliary track losses serve an important role in ensuring consistency of object identities

Referring now to block 140 of FIG. 1 showing an embodiment of a method of training the transformer-based model using the differentiable loss and contiguous video segments sampled from a training dataset to track multiple objects with multiple cameras.

The differentiable loss [symbol] _{final} can be computed as:

$${ℒ}_{final} = {ℒ}_{det} + {ℒ}_{det \_ aux} + {ℒ}_{track} + {ℒ}_{aux \_ track}$$

The training can proceed based on contiguous video segments which are sampled randomly from the training data.

For the epochs in the beginning (e.g., thirty), the video segments are short (e.g., four frame clips). This stage of training is used to ensure that the model sees diverse data, which is especially important for the detector models. After this initial stage, the parameters of the detector module are frozen, and the training of the tracking and association modules continues on increasingly longer video segments. The length of the video segments can be randomly chosen from a geometric distribution with the expected value increasing linearly as training progresses. The video segments can be split into non-overlapping number of frame clips (e.g., four), with each clip serving as a training instance. At the beginning of the video segment the track embeddings are set to an initial embedding (which is learned). For each subsequent clip, the track embeddings are initialized with the final track embeddings from the previous clip.

A post-processing step can be performed where new and old tracks are merged when a track ID disappears from a view, and a new track ID appears at the same place to maintain long horizon tracking.

After training, the trained MCTR can be obtained. The trained MCTR can be employed to do downstream tasks such as anomaly detection, fine-grained object detection, multi-entity tracking, etc. These downstream tasks can be further used in practical applications for the trained MCTR.

The present embodiments improve the accuracy and effectiveness of object detection models by increasing coverage, reducing blind spots and occlusions, and increasing tracking robustness over other methods.

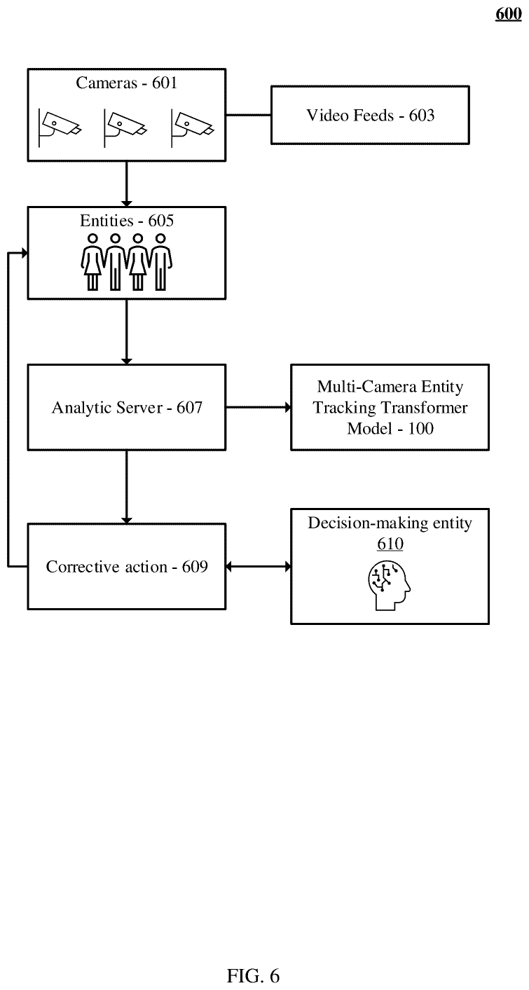

Referring now to FIG. 6 that shows a block diagram of a system for tracking multiple objects with multiple cameras using a transformer-based model, in accordance with an embodiment of the present invention.

The system 600 can perform practical applications in the security, healthcare, manufacturing fields. The system 600 can include cameras 601 to capture video feeds 603 which can collect data from monitored entities 605. The system 600 can include an analytic server 607 that can implement the multi-camera entity tracking transformer model 100. The analytic server 607 can receive the video feeds 603 through a network. The analytic server 607 can perform corrective action 609 for the monitored entities 605.

In the manufacturing field, the monitored entities 605 can be product going through an assembly line and the corrective action 609 can be halting production for a product detected to be anomalous (e.g., not up to standard, broken, exceeded a certain threshold, etc.). In the healthcare field, the monitored entities 605 can be patients within a hospital ward and the corrective action 609 can be updating the medical diagnosis of the patients. In the retail field, the monitored entities 605 can be products for sale and the corrective action can be replenishing the products after a threshold has been met. In the security field, the monitored entities 605 can be important people that hired security detail to protect them and the corrective action 609 can be adding security around the monitored entities 605. In the law enforcement field, the monitored entities 605 can be persons of interest related to an investigation and the corrective action 609 can be deploying a drone to assist the investigation, etc. Other fields are contemplated.

In another embodiment, the corrective action 609 can be sent to a decision-making entity 610 as a recommendation and the decision-making entity 610 can approve or disapprove the recommendation.

Other practical applications are contemplated.

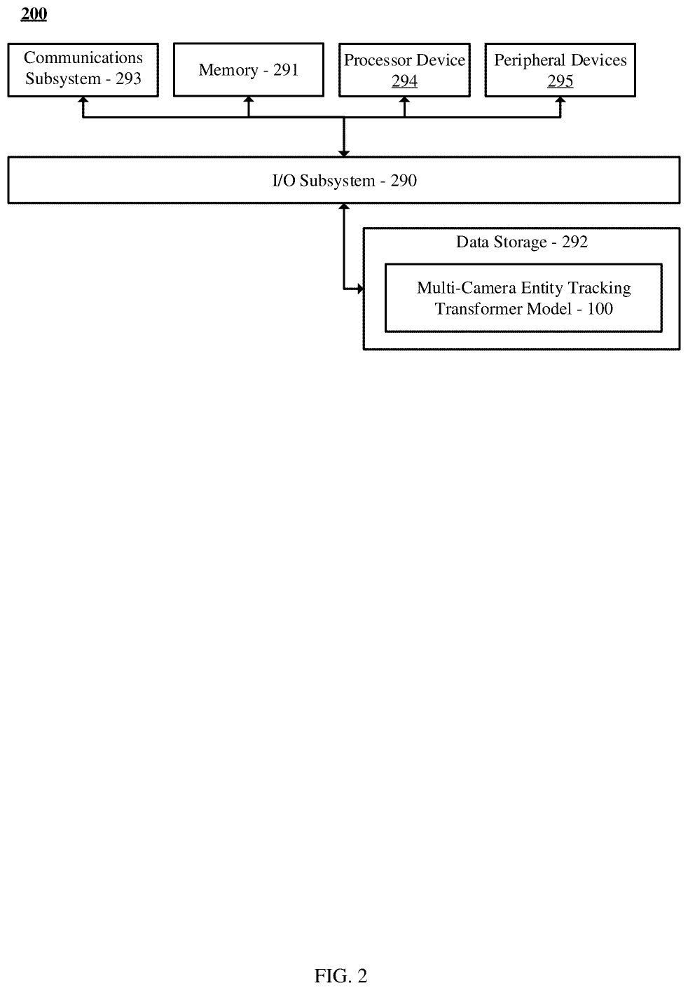

Referring now to FIG. 2, a system for a multi-camera entity tracking transformer model is illustratively depicted in accordance with an embodiment of the present invention.

The computing device 200 illustratively includes the processor device 294, an input/output (I/O) subsystem 290, a memory 291, a data storage device 292, and a communication subsystem 293, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 291, or portions thereof, may be incorporated in the processor device 294 in some embodiments.

The processor device 294 may be embodied as any type of processor capable of performing the functions described herein. The processor device 294 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 291 may be embodied as any type of volatile or non-volatile memory or data storage capable of performing the functions described herein. In operation, the memory 291 may store various data and software employed during operation of the computing device 200, such as operating systems, applications, programs, libraries, and drivers. The memory 291 is communicatively coupled to the processor device 294 via the I/O subsystem 290, which may be embodied as circuitry and/or components to facilitate input/output operations with the processor device 294, the memory 291, and other components of the computing device 200. For example, the I/O subsystem 290 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 290 may form a portion of a system-on-a-chip (SOC) and be incorporated, along with the processor device 294, the memory 291, and other components of the computing device 200, on a single integrated circuit chip.

The data storage device 292 may be embodied as any type of device or devices configured for short-term or long-term storage of data such as, for example, memory devices and circuits, memory cards, hard disk drives, solid state drives, or other data storage devices. The data storage device 292 can store program code for a multi-camera entity tracking transformer model 100. Any or all of these program code blocks may be included in a given computing system.

The communication subsystem 293 of the computing device 200 may be embodied as any network interface controller or other communication circuit, device, or collection thereof, capable of enabling communications between the computing device 200 and other remote devices over a network. The communication subsystem 293 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 200 may also include one or more peripheral devices 295. The peripheral devices 295 may include any number of additional input/output devices, interface devices, and/or other peripheral devices. For example, in some embodiments, the peripheral devices 295 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 200 are readily contemplated by one of ordinary skill in the art given the teachings of the present invention provided herein.

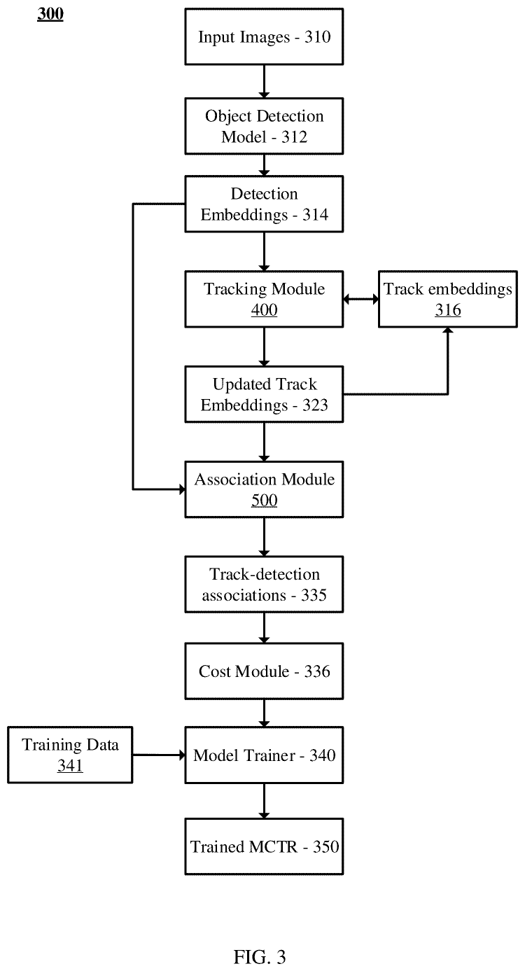

Referring now to FIG. 3, a block diagram illustrating a system for a multi-camera entity tracking transformer model, in accordance with an embodiment of the present invention.

System 300 for a multi-camera entity tracking transformer model can include several machine learning models such as the object detection model 312, the tracking module 400 and the association module 500 to obtain a trained MCTR 350. In an embodiment, input images 310 can be fed into an object detection model 312 to obtain detection embeddings 314. The object detection model can be a transformer-based model for object detection such as a detection transformer (DETR). Other transformer-based models can be employed. The detection embeddings 314 can be fed to the tracking module 400 to obtain track embeddings 316 which can be fed again to the tracking module 400 to obtain updated track embeddings 323. The detection embeddings 315 and the updated track embeddings 323 can be fed to the association module 500 to obtain track-detection associations (TDA) 335. The TDA 335, the detection embeddings 314 and the updated track embeddings 323 can be used by the cost module 336 to compute the differentiable loss function. The differentiable loss function and the training data 341 can be used by the model trainer 340 to train the MCTR to obtain the trained MCTR 350.

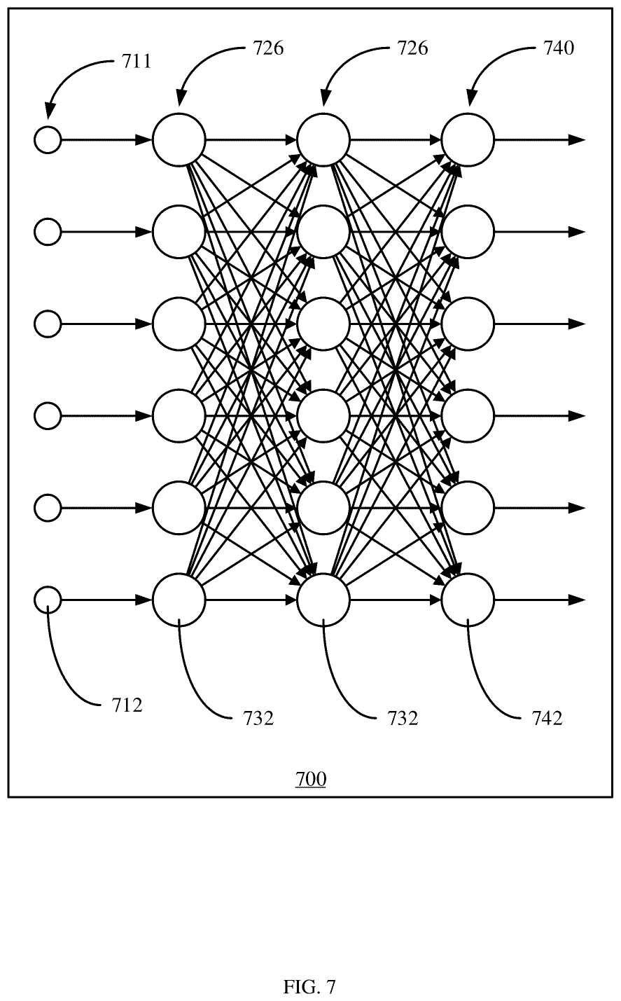

Referring now to FIG. 7, a block diagram illustrating deep learning neural networks for a multi-camera entity tracking transformer model, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 700, such as a multilayer perceptron, can have an input layer 711 of source neurons 712, one or more computation layer(s) 726 having one or more computation neurons 732, and an output layer 740, where there is a single output neuron 742 for each possible category into which the input example could be classified. An input layer 711 can have a number of source neurons 712 equal to the number of data values 712 in the input data 711. The computation neurons 732 in the computation layer(s) 726 can also be referred to as hidden layers, because they are between the source neurons 712 and output neuron(s) 742 and are not directly observed. Each neuron 732, 742 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, W₂, . . . Wₙ₋₁, Wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 726 of the detection MLP 503 of the association module 500 can learn relationships between detection embeddings 316 and updated track embeddings 323. The output layer 740 of the detection MLP 503 of the association module 500 can then provide the overall response of the network as a likelihood score of relevance of between detection embeddings 316 and updated track embeddings 323. In an embodiment, the computation layers 726 of the track MLP 505 of the association module 500 can learn relationships between detection embeddings 316 and updated track embeddings 323. The output layer 740 of the track MLP 505 of the association module 500 can then provide the overall response of the network as a likelihood score of relevance of between detection embeddings 316 and updated track embeddings 323.

In an embodiment, the tracking module 400 can learn the relationship between objects within images and tracks depending on the camera position.

In another embodiment, the object detection model 312 can identify associations between an input image 310 and object attributes within the input image 310 to predict categories.

Training a deep neural network can involve two phases, a forward phase where the weights of each neuron are fixed and the input propagates through the network, and a backwards phase where an error value is propagated backwards through the network and weight values are updated. The computation neurons 732 in the one or more computation (hidden) layer(s) 726 perform a nonlinear transformation on the input data 712 that generates a feature space. The classes or categories may be more easily separated in the feature space than in the original data space.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for tracking multiple objects with multiple cameras using a transformer-based model (MCTR), comprising:
processing track embeddings and detection embeddings of video feeds obtained from multiple cameras to generate updated track embeddings;
associating the updated track embeddings with the detection embeddings to generate track-detection associations (TDA) for each camera view and camera frame;
calculating a differentiable loss from the TDA by combining a detection loss, a track loss, and an auxiliary track loss; and
training the MCTR using the differentiable loss and contiguous video segments sampled from a training dataset to track multiple objects with multiple cameras to obtain a trained MCTR.

2. The computer-implemented method of claim 1, further comprising detecting anomalies from monitored entities within a specified location using the trained MCTR to assist a decision-making process of a decision-making entity.

3. The computer-implemented method of claim 1, wherein processing the track embeddings further comprises aggregating observations from a frame into a global track embeddings through self-attention and feed-forward layers.

4. The computer-implemented method of claim 3, wherein aggregating the observations further comprises performing cross attention between the track embeddings and the detection embeddings.

5. The computer-implemented method of claim 1, wherein associating the updated track embeddings further comprises performing linear transformation on the detection embeddings and track embeddings using respective multi-layer perceptrons (MLP) to obtain detection matrices and track matrices.

6. The computer-implemented method of claim 5, wherein associating the updated track embeddings further comprises applying row-wise softmax operation to a dot-product of the detection matrices and track matrices.

7. The computer-implemented method of claim 1, wherein calculating the differentiable loss further comprises computing the detection loss by finding a bipartite assignment of detections to ground truth.

8. The computer-implemented method of claim 1, wherein calculating the differentiable loss further comprises computing the track loss as the combination of negative log-likelihoods of pairs of detections from different camera views in a same frame.

9. The computer-implemented method of claim 1, wherein calculating the differentiable loss further comprises computing the auxiliary track loss as a sum of all detections associated with a ground truth annotation by Hungarian matching for a view and an intersection over union loss for bounding boxes for respective tracks and views and bounding boxes for a ground truth annotation for all tracks, views, and ground truth annotations.

10. A system for tracking multiple objects with multiple cameras using a transformer-based model (MCTR), comprising:
a memory device;
one or more processor devices operatively coupled with the memory device to:
process track embeddings and detection embeddings of video feeds obtained from multiple cameras to generate updated track embeddings;
associate the updated track embeddings with the detection embeddings to generate track-detection associations (TDA) for each camera view and camera frame;
calculate a differentiable loss from the TDA by combining a detection loss, a track loss and an auxiliary track loss; and
train the MCTR using the differentiable loss and contiguous video segments sampled from a training dataset to track multiple objects with multiple cameras to obtain a trained MCTR.

11. The system of claim 10, further comprising to detect anomalies from monitored entities within a specified location using the trained MCTR to assist a decision-making process of a decision-making entity.

12. The system of claim 10, wherein to process the track embeddings further comprises to aggregate observations from a frame into a global track embeddings through self-attention and feed-forward layers.

13. The system of claim 12, wherein to aggregate the observations further comprises performing cross attention between the track embeddings and the detection embeddings.

14. The system of claim 10, wherein to associate the updated track embeddings further comprises performing linear transformation on the detection embeddings and track embeddings using respective multi-layer perceptrons (MLP) to obtain detection matrices and track matrices.

15. The system of claim 14, wherein to associate the updated track embeddings further comprises applying row-wise softmax operation to a dot-product of the detection matrices and track matrices.

16. The system of claim 10, wherein to calculate the differentiable loss further comprises computing the detection loss by finding a bipartite assignment of detections to ground truth.

17. The system of claim 10, wherein to calculate the differentiable loss further comprises computing the track loss as the combination of negative log-likelihoods of pairs of detections from different camera views in a same frame.

18. The system of claim 10, wherein to calculate the differentiable loss further comprises computing the auxiliary track loss as a sum of all detections associated with a ground truth annotation by Hungarian matching for a view and an intersection over union loss for bounding boxes for respective tracks and views and bounding boxes for a ground truth annotation for all tracks, views, and ground truth annotations.

19. A non-transitory computer program product comprising a computer-readable storage medium including program code for tracking multiple objects with multiple cameras using a transformer-based model (MCTR), wherein the program code when executed on a computer causes the computer to:
process track embeddings and detection embeddings of video feeds obtained from multiple cameras to generate updated track embeddings;
associate the updated track embeddings with the detection embeddings to generate track-detection associations (TDA) for each camera view and camera frame;
calculate a differentiable loss from the TDA by combining a detection loss, a track loss and an auxiliary track loss; and
train the MCTR using the differentiable loss and contiguous video segments sampled from a training dataset to track multiple objects with multiple cameras to obtain a trained MCTR.

20. The non-transitory computer program product of claim 19, further comprising to detect anomalies from monitored entities within a specified location using the trained MCTR to assist a decision-making process of a decision-making entity.
